(19) United States
(12) Patent Application Publication
(10) Pub. No.: US 2011/0009008 A1
(43) Pub. Date: Jan. 13, 2011

(54) USB A-TYPE SOCKET

(75) Inventor: Jung Jui Wang, Taipei City (TW)

Correspondence Address: ROGER H. CHU, 19499 ERIC DRIVE, SARATOGA, CA, 95070, US

(73) Assignee: COMPUPACK TECHNOLOGY CO., LTD., Taipei (TW)

(21) Appl. No.: 12/500,409

(22) Filed: Jul. 9, 2009

(51) Int. Cl. H01R 24/00

(52) U.S. Cl. 439/660

(57) ABSTRACT

A USB (Universal Serial Bus) A-type socket configured for coupling with a USB A-type plug complies with the USB 3.0 specification and includes a composite member, a plurality of second terminals, and a metal housing. The composite member includes a plurality of first terminals and an insulating body, wherein the insulating body partially wraps and firmly holds the first terminals. The second terminals are assembled to guiding rails provided on the composite member. The metal housing encloses the composite member. Since the first terminals and the insulating body are integrated as the one-piece composite member, positional stability of the first terminals is ensured.

### BACKGROUND OF THE INVENTION

1. Technical Field

The present invention relates to electronic connectors and, more particularly, to a standard USB (Universal Serial Bus) A-type socket that complies with the USB 3.0 specification.

2. Description of Related Art

The USB interface is the most popular transmission interface for IT products nowadays. For example, USB compatible connectors are extensively used in various peripherals for computers and digital audio-video devices, such as mice, keyboards, memory sticks, card readers, and so on, for convenient and rapid data transmission.

Since the introduction of USB Specification Version 1.0 in 1996, the USB-related technology has progressed considerably so that the USB 3.0 Specification was published in 2008, providing a transmission rate up to 4.8 Gbps. Structurally speaking, both USB 1.x and USB 2.0 use four contacts, namely a pair of power cords and a pair of differential signaling lines, for half-duplex transmission. Differently, USB 3.0 uses five contacts for full-duplex transmission, wherein the five contacts are two pairs of signaling lines serving to convey and receive data, respectively, and a grounding line.

In order to provide backward compatibility with USB 1.x and USB 2.0 devices, the USB 3.0 interface features a dual-transmission structure, which is briefly explained below.

Please refer to FIGS. 1 and 2. FIG. 1 is a perspective drawing showing application of a USB A-type socket, wherein a USB A-type plug 10 and a USB A-type socket 20, both complying with the USB 3.0 specification, are depicted. As shown in FIG. 1, the USB A-type plug 10 is to be inserted into the USB A-type socket 20 to form a USB-interface connection for signal transmission.

FIG. 2 shows arrangement of terminals in the USB A-type plug 10 and the USB A-type socket 20. According to the drawing, the USB A-type plug 10 has five first plug terminals 11a, 11b, 11c, 11d, and 11e and four second plug terminals 12a, 12b, 12c, and 12d. The USB A-type socket 20 has five first socket terminals 21a, 21b, 21c, 21d, and 21e and four second socket terminals 22a, 22b, 22c, and 22d.

The first plug terminals 11a through 11e are resilient pins arranged as in a pin header and configured for coupling with the first socket terminals 21a through 21e, which are in the form of gold fingers, so as to achieve electrical conduction. The first plug terminals 11a through 11e and the first socket terminals 21a through 21e are of the transmission system that complies with the Super Speed USB 3.0 specification.

The second plug terminals 12a through 12d are in the form of gold fingers and are configured for coupling with the second socket terminals 22a through 22d, which are resilient pin arranged as in a pin header, so as to achieve electrical conduction. The second plug terminals 12a through 12d and the second socket terminals 22a through 22d are of the transmission system that complies with the USB 2.0 specification for transmission at Low Speed, Full Speed, and High Speed, as known in the art.

It can be learned from the above description that the USB A-type socket 20 includes two transmission systems supported by different mechanisms. Therein, the first socket terminals 21a through 21e complying with the Super Speed USB 3.0 specification are in the form of gold fingers while the second socket terminals 22a through 22d complying with the USB 2.0 specification are resilient pins arranged as in a pin header.

Traditionally, according to the USB 1.x and USB 2.0 specifications, terminals of a USB A-type socket are resilient pins arranged in a row, as in a pin header. During manufacture, the terminals are inserted in a body of the USB A-type socket so as to be secured in position. However, this assembling process may sometimes result in askew positioned terminals. Particularly, after the USB technology stepped into the era of the 3.0 Version, the number of terminals in a USB A-type socket has increased to nine, which increases the risk of defective assembly. An ill-performed assembling process not only causes the actual dimensions of terminals to deviate from design, but also brings adverse effects to the electrical properties, and thus lowers the reliability, of finished products so that consumers' rights are compromised.

### SUMMARY OF THE INVENTION

Therefore, one objective of the present invention is to provide a USB A-type socket which complies with the USB 3.0 specification and in which first terminals complying with the Super Speed USB 3.0 specification and an insulating body are integrated as a composite member so that the insulating body partially wraps and firmly holds the first terminals. Consequently, positional stability of the first terminals is increased so as to ensure excellent electronic property and reliability of the disclosed USB A-type socket.

The disclosed USB A-type socket is designed according to the USB 3.0 specification.

The disclosed USB A-type socket comprises the composite member, a plurality of second terminals, and a metal housing, wherein the composite member includes the plurality of first terminals and the insulating body. The insulating body has a board and serves to partially wrap and firmly hold the first terminals. A plurality of bores and a plurality of guiding rails are formed on the board, wherein the first terminals are exposed at the bores, thus forming a plurality of conducting zones. The second terminals are assembled to the composite member through the guiding rails. The metal housing has an opening and encloses the composite member so that an accommodating recess is defined by the opening and the board of the insulating body, wherein the conducting zones and the guiding rails face the accommodating recess. Thus, the accommodating recess is ready to receive a USB A-type plug.

Therein, the first terminals comply with the Super Speed USB 3.0 specification, and the second terminals comply with the USB 2.0 specification.

The present invention further provides a stacked USB socket including a plurality of the aforesaid USB A-type sockets.

Therefore, the USB A-type socket of the present invention has the first terminals and the insulating body integrated as the one-piece composite member so that the insulating body firmly holds the first terminals and thereby ensures positional stability of the first terminals. Consequently, the USB A-type socket conforms to design specifications and provides the desired electronic properties, thus improving the reliability of the USB A-type socket.

### BRIEF DESCRIPTION OF THE DRAWINGS

The invention as well as a preferred mode of use, further objectives, and advantages thereof will be best understood by reference to the following detailed description of an illustrative embodiment when read in conjunction with the accompanying drawings, wherein:

FIG. 1 is a perspective drawing showing application of a USB A-type socket;

FIG. 2 shows arrangement of terminals in the USB A-type socket and a USB A-type plug of FIG. 1;

FIG. 3 is an exploded perspective view of a USB A-type socket of the present invention;

FIG. 4 is another exploded perspective view of the USB A-type socket of the present invention; and

FIGS. 5, 6 and 7 are perspective views of the USB A-type socket of the present invention taken from different viewing angles.

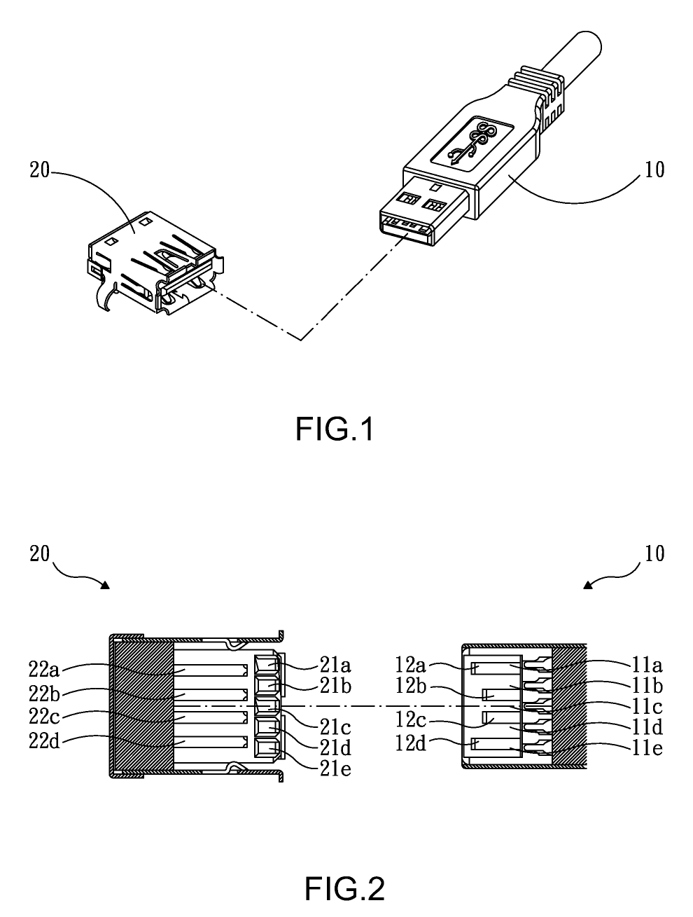

### DETAILED DESCRIPTION OF THE PREFERRED EMBODIMENTS

The present invention provides a USB A-type socket that complies with the USB 3.0 specification and is configured for coupling with a standard USB 3.0 A-type plug.

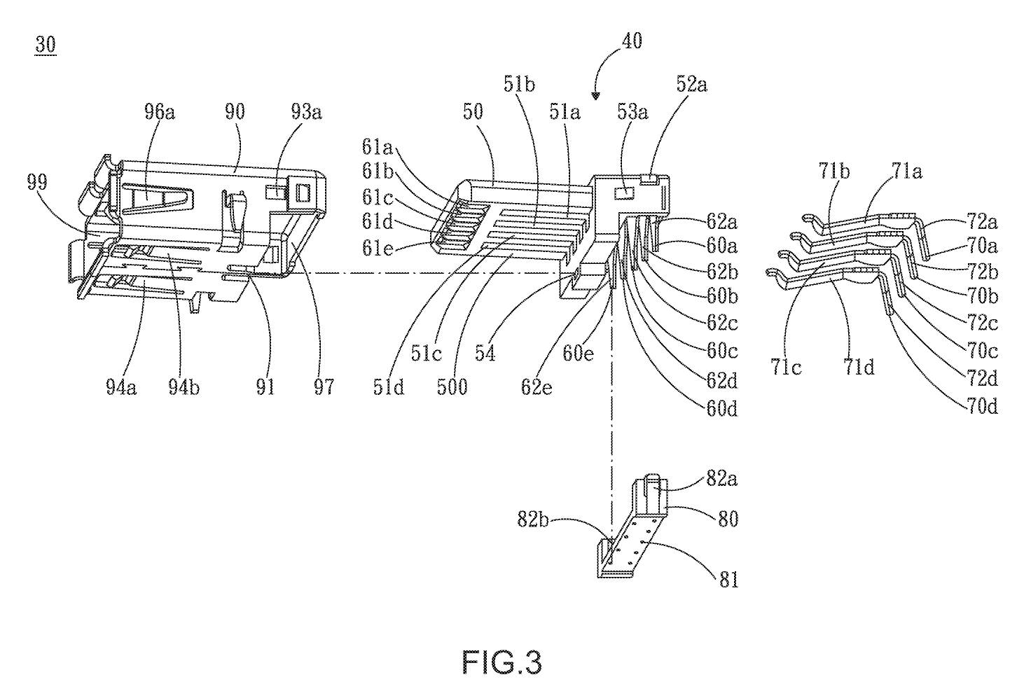

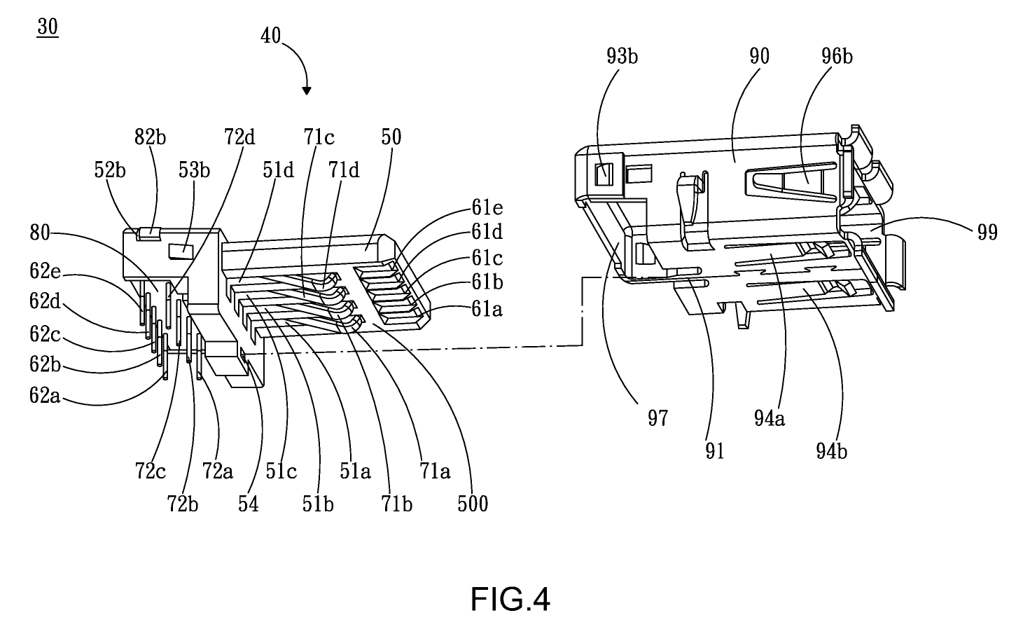

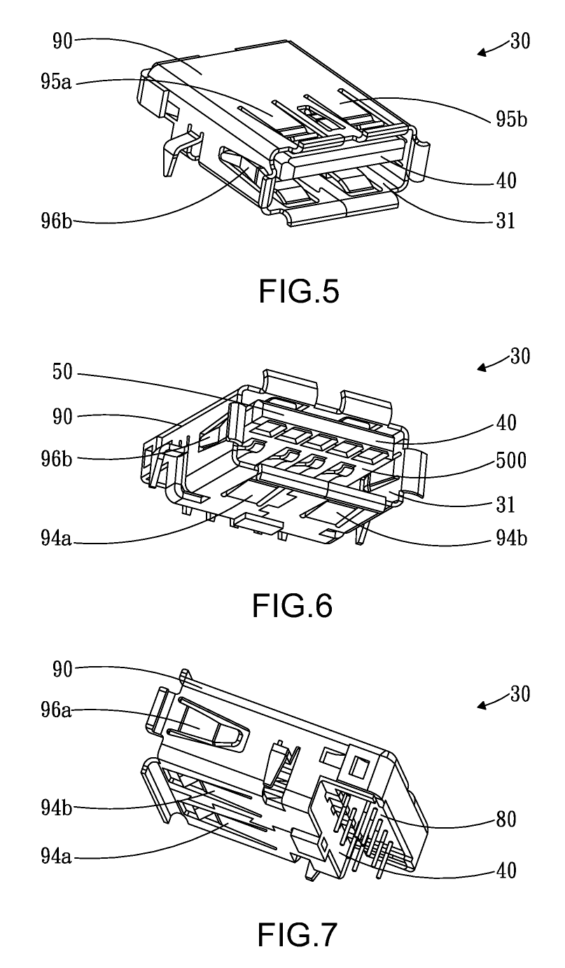

Please refer to FIGS. 3 through 7 for an embodiment of the present invention, wherein FIG. 3 is an exploded perspective view of the USB A-type socket of the present invention, FIG. 4 is another exploded perspective view of the USB A-type socket of the present invention, and FIGS. 5 through 7 are perspective views of the USB A-type socket of the present invention taken from different viewing angles.

As shown in the drawings, the USB A-type socket 30 primarily comprises a composite member 40, four electrically conductive second terminals 70a through 70d, a seat 80, and a metal housing 90. The composite member 40 includes five electrically conductive first terminals 60a through 60e and an insulating body 50. The insulating body 50 partially wraps and firmly holds the first terminals 60a through 60e. In the depicted embodiment, the first terminals 60a through 60e are L-shaped terminals having pins 62a, 62b, 62c, 62d, and 62e, respectively. Meantime, the second terminals 70a through 70d are also depicted as L-shaped terminals and have resilient arms 71a through 71d and pins 72a through 72d, respectively.

According to the USB 3.0 specification, a USB A-type socket includes two transmission systems which have different mechanical structures so as to match and couple with different kinds of external plugs for electrical conduction. In the USB A-type socket 30, the first terminals 60a through 60e are of the transmission system according to the Super Speed USB specification and have contacts configured as gold fingers for connecting with external plugs. On the other hand, the second terminals 70a through 70d are of the transmission system according to the USB 2.0 specification which enable transmission in Low Speed, Super Speed, and High Speed, as known in the art, and have contacts configured as resilient pin arranged similarly to pins in a pin header so as to connect with external plugs.

The present invention is characterized in that the first terminals 60a through 60e and the insulating body 50 are integrally formed, but not assembled, into the one-piece composite member 40 so that the insulating body 50 partially wraps and firmly holds the first terminals 60a through 60e. Thus, positional stability of the first terminals 60a through 60e is ensured, and in consequence the USB A-type socket 30 conforms to design specifications, particularly in terms of spacing between the first terminals 60a through 60e. For a Super Speed USB 3.0 interface, any minute dimensional error in the socket can bring adverse effects to high-frequency signal transmission. Hence, the present invention aims at making the socket conform dimensionally to design and preventing components of the socket from being deflected by external force, so that the product has the electronic properties set forth in the USB 3.0 specification as well as enhanced reliability.

In an embodiment of the present invention, the composite member 40 is made by an element-forming process. According to the material requirements set forth in the USB 3.0 specification, the insulating body 50 is injection molded from thermoplastic, wherein the injection mold is designed according to the dimensions of the elements involved. During the injection molding process, the first terminals 60a through 60e are settled in the mold, and then thermoplastic is injected into the mold to form the insulating body 50. By means of thermal formation of the thermoplastic, the insulating body 50 is in tight contact with the first terminals 60a through 60e while the pins 62a through 62e are exposed. Thereby, the composite member 40 is endowed with excellent mechanical stability.

Furthermore, in the composite member 40, the insulating body 50 includes a board that has a surface 500 formed with a plurality of bores so that the first terminals 60a through 60e are exposed at the surface 500 of the board of the insulating body 50 through the bores, thereby forming five conducting zones 61a, 61b, 61c, 61d, and 61e. The surface 500 of the board is further formed with a plurality of guiding rails 51a, 51b, 51c, and 51d for allowing the second terminals 70a through 70d to assemble with the composite member 40 in such a way that the resilient arms 71a through 71d are exposed at the surface 500 of the board.

The seat 80 has a plurality of terminal guiding holes 81 for receiving and thus positioning the pins 62a through 62e and the pins 72a through 72d when the seat 80 is assembled to the composite member 40. The insulating body 50 has retaining holes 52a and 52b while the seat 80 has resilient retaining fins 82a and 82b to be inserted into and thus retained by the retaining holes 52a and 52b so that the seat 80 is secured in position to the composite member 40.

The metal housing 90 is a rectangular frame having two openings 97, 99, a positioning pin 91, and two retaining holes 93a, 93b. The composite member 40 has a retaining hole 54 and two resilient retaining fins 53a, 53b. After the composite member 40, the seat 80, and the second terminals 70a through 70d are assembled together, the resultant assembly is inserted into the metal housing 90 through the opening 97 so that the positioning pin 91 is retained in the retaining hole 54 while the resilient retaining fins 53a, 53b are retained in the retaining holes 93a, 93b, thereby positioning the assembly in the metal housing 90. Consequently, the surface 500 of the board of the insulating body 50 and the metal housing 90 jointly define an accommodating recess 31 for receiving a USB A-type plug inserted thereinto through the opening 99 so that the conducting zones 61a through 61e and the resilient arms 71a through 71d are in electrical conduction with terminals of the USB A-type plug for signal transmission.

The metal housing 90 has an electromagnetic shielding function and thus includes a grounding contact and other required structures. Tongues 94a, 94b, 95a, 95b, 96a, 96b are provided on walls of the metal housing 90 for helping positioning the USB A-type plug.

As the USB A-type socket 30 is subject to the USB 3.0 specification in terms of pin arrangement, overall dimensions, material, among other details, further description of all those details that are set forth in the USB 3.0 specification is omitted herein for brevity.

Besides, in view of the extensive application of the USB interface, many IT devices, such as computers, have adopted stacked USB sockets for connecting with multiple devices. Thus, the concept of the USB A-type socket according to the present invention can be further applied to realize a stacked USB socket composed of a plurality of the USB A-type sockets according to the present invention. In such a case, however, the first terminals and the second terminals as well as the metal housing may require modification in structure or dimension. For example, it may be necessary to increase or decrease the dimensions of the terminals according to the height of the stacked USB socket and modify the metal housing correspondingly.

In conclusion, according to the present invention, the composite member of the USB A-type socket is formed by integrating into one piece the insulating body and the first terminals that are of the transmission system complying with Super Speed USB specification, so that the insulating body firmly holds the first terminals to enhance positional stability thereof and make the socket conform to design specifications, thus ensuring the electronic properties and reliability of the USB A-type socket.

The present invention has been described by reference to the preferred embodiment, and it is understood that the embodiment is not intended to limit the scope of the present invention, which is defined only by the appended claims. Therefore, all equivalent changes or modifications which are readily conceivable by a person skilled in the art and do not depart from the concept of the present invention should be encompassed by the appended claims.

What is claimed is:

1. A USB (Universal Serial Bus) A-type socket complying with the known USB 3.0 specification, the USB A-type socket comprising:
a composite member including:
a plurality of first terminals; and
an insulating body having a board, the insulating body partially wrapping and firmly holding the first terminals, the board having a surface provided with a plurality of bores and a plurality of guiding rails, wherein the first terminals are exposed at the bores to form a plurality of conducting zones;
a plurality of second terminals assembled to the composite member through the guiding rails; and
a metal housing having an opening, the metal housing enclosing the composite member, wherein the opening and the board of the insulating body jointly define an accommodating recess so that the conducting zones and the guiding rails face the accommodating recess,
wherein the accommodating recess is ready to receive an external USB A-type plug.

2. The USB A-type socket of claim 1, wherein the insulating body is made of thermoplastic.

3. The USB A-type socket of claim 2, wherein the insulating body is made by the way of injection molding so as to partially wrap and firmly hold the first terminals.

4. The USB A-type socket of claim 1, wherein each of the first terminals and the second terminals has a pin exposed outside the composite member.

5. The USB A-type socket of claim 4, further comprising a seat assembled to the composite member, wherein the seat has a plurality of terminal guiding holes corresponding in position to the pins of the first terminals and the pins of the second terminals so as to receive and position the pins of the first terminals and the pins of the second terminals.

6. The USB A-type socket of claim 5, wherein the seat has at least a resilient retaining fin, and the composite member has at least a retaining hole corresponding in position to the resilient retaining fin so as to retain the resilient retaining fin.

7. The USB A-type socket of claim 1, wherein each said second terminal has a resilient arm so that when the second terminals are assembled to the composite member, the resilient arms of the second terminals are exposed at the surface of the board of the insulating body.

8. The USB A-type socket of claim 1, wherein the composite member has at least a resilient retaining fin, and the metal housing has a retaining hole corresponding in position to the resilient retaining fin so as to retain the resilient retaining fin.

9. The USB A-type socket of claim 1, wherein the metal housing has positioning pin, and the composite member has a retaining hole corresponding in position to the positioning pin so as to retain the positioning pin.

10. The USB A-type socket of claim 1, wherein the metal housing has at least a tongue.

11. The USB A-type socket of claim 1, wherein the first terminals are of a transmission system complying with the known Super Speed USB specification, and the second terminals are of a transmission system complying with the known USB 2.0 specification.

12. A stacked USB socket composed of plural USB A-type sockets, wherein the USB A-type sockets are as claimed in claim 1.
